(19) United States
(12) Patent Application Publication
(10) Pub. No.: US 2020/0040180 A1
(43) Pub. Date: Feb. 6, 2020

(54) POLYCARBONATE RESIN COMPOSITION AND MOLDED ARTICLE THEREOF

(71) Applicant: KANEKA CORPORATION, Osaka-shi, Osaka (JP)

(72) Inventors: Keika HATTORI, Settsu-shi (JP); Shusuke YOSHIHARA, Settsu-shi (JP)

(73) Assignee: KANEKA Corporation, Osaka-shi, Osaka (JP)

(21) Appl. No.: 16/090,768

(22) PCT Filed: Apr. 5, 2017
(86) PCT No.: PCT/JP2017/014200

§ 371 Date: Oct. 2, 2018

(30) Foreign Application Priority Data
Apr. 6, 2016 (JP) 2016-076237

(51) Int. Cl. C08L 69/00; C08G 63/195; C08K 5/527

(52) U.S. Cl. CPC C08L 69/00; C08G 63/195; C08L 2205/03; C08L 2205/025; C08K 5/527

(57) ABSTRACT

Provided is a polycarbonate resin composition containing a polycarbonate resin whose flowability during molding of the polycarbonate resin is enhanced, without loss of properties such as transparency, mechanical strength, and heat resistance, by adding, to the polycarbonate resin, a polycarbonate oligomer and a flowability enhancing agent which is obtained through polycondensation of a monomer mixture containing a bisphenol component and a dicarboxylic acid and, optionally, biphenol component. Further provided is a molded article obtained from the polycarbonate resin composition.

### TECHNICAL FIELD

The present invention relates to a polycarbonate resin composition containing (i) an additive for enhancing flowability of a polycarbonate resin during molding of the polycarbonate resin, without loss of inherent properties (for example, transparency, mechanical strength, and heat resistance) of the polycarbonate resin and (ii) a polycarbonate oligomer. The present invention further relates to a molded article obtained from the polycarbonate resin composition.

### BACKGROUND ART

A molded article made of a polycarbonate resin is excellent in, for example, transparency, impact resistance, heat resistance, dimensional stability, and self-extinguishing property (flame retardancy), and is therefore in wide use, for example, in the fields of electric equipment, electronic equipment, office-automation (OA) equipment, optical parts, precision machinery, motor vehicles, security and medical care, building materials, and sundry goods. However, the polycarbonate resin is typically amorphous; thus, the polycarbonate resin requires a high molding temperature and is inferior in melt flowability.

Recent years have seen polycarbonate resin composition molded articles becoming larger, thinner, more complicated in shape, and better in properties as well as a growing interest in environmental problems. This has led to a demand for (i) a resin modifier for enhancing melt flowability and injection moldability of a polycarbonate resin composition without impairing excellent properties of a molded article made of a polycarbonate resin and (ii) a polycarbonate resin composition containing the resin modifier.

Patent Literature 1, for example, discloses a method for improving flowability by mixing polycarbonate resins having respective different molecular weights.

### CITATION LIST

### Patent Literature

[Patent Literature 1]

Japanese Patent Application Publication, Tokukaihei, No. 9-208684 (1997)

### SUMMARY OF INVENTION

### Technical Problem

However, merely mixing polycarbonate resins having respective different molecular weights, as in Patent Literature 1, may cause a decrease in impact strength. This makes it difficult to achieve both impact strength and flowability.

An object of the present invention is to provide (a) a polycarbonate resin composition containing (i) an additive for enhancing flowability of a polycarbonate resin during molding of the polycarbonate resin, without loss of inherent properties (for example, transparency, mechanical strength, and heat resistance) of the polycarbonate resin and (ii) a polycarbonate oligomer and (b) a molded article obtained from the polycarbonate resin composition.

### Solution to Problem

The inventors of the present invention conducted diligent studies and consequently found that it is possible to enhance flowability of a polycarbonate resin during molding of the polycarbonate resin, without loss of inherent useful properties (for example, transparency, mechanical strength, and heat resistance) of the polycarbonate resin, by melting and kneading the polycarbonate resin, a polycarbonate oligomer, and a flowability enhancing agent which serves as a component for enhancing the flowability of the polycarbonate resin and which includes a polyester obtained through polycondensation of a bisphenol component and an aliphatic dicarboxylic acid component and, optionally, a biphenol component in specific proportions. As a result, the inventors of the present invention completed the present invention. Specifically, the present invention encompasses inventions as shown in the following 1) through 6).

1) A polycarbonate resin composition including:

a flowability enhancing agent;

a polycarbonate oligomer; and

a polycarbonate resin,

the flowability enhancing agent including a polycondensate of a monomer mixture containing a biphenol component (A) in a proportion of 0 mol % to 55 mol %, a bisphenol component (B) in a proportion of 5 mol % to 60 mol %, and a dicarboxylic acid component (C) in a proportion of 40 mol % to 60 mol %, with respect to 100 mol % of a total amount of the biphenol component (A), the bisphenol component (B), and the dicarboxylic acid component (C),

the biphenol component (A) being represented by the following general formula (1):

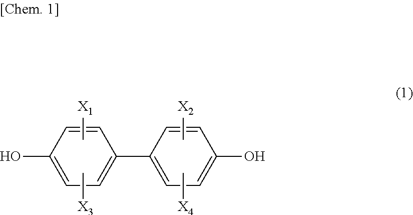

where X₁ through X₄ each independently represent a hydrogen atom, a halogen atom, or an alkyl group having 1 to 4 carbon atom(s) and may be identical to or different from each other,

the bisphenol component (B) being represented by the following general formula (2):

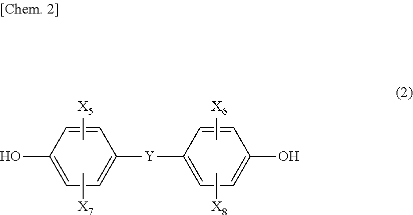

where: X₅ through X₈ each independently represent a hydrogen atom, a halogen atom, or an alkyl group having 1 to 4 carbon atom(s) and may be identical to or different from each other; Y represents a methylene group, an isopropylidene group, a cyclic alkylidene group, an aryl-substituted alkylidene group, an arylenedialkylidene group, —S—, —O—, a carbonyl group, or —SO₂—,
the dicarboxylic acid component (C) being represented by the following general formula (3):

HOOC—R₁—COOH (3)

where R₁ represents a divalent linear substituent which has 2 to 18 atoms in its main chain and which may contain a branch,

the polycarbonate oligomer having a structural unit which is represented by the following general formula (4) and of which average number of repetitions is 2 to 15:

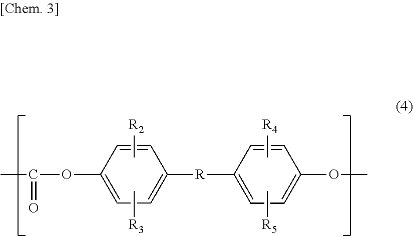

where: R represents a linear, branched, or cyclic alkylidene group having 1 to 10 carbon atom(s), an aryl-substituted alkylidene group, an arylenedialkylidene group, an oxygen atom, a sulfur atom, a carbonyl group, or a sulfonyl group; and R₂ through R₅ each independently represent a hydrogen atom, a halogen atom, or an alkyl or alkenyl group having 1 to 4 carbon atom(s) and may be identical to or different from each other,

the polycarbonate resin having a viscosity average molecular weight of not less than 15,000.

2) The polycarbonate resin composition described in 1), wherein the flowability enhancing agent has a number average molecular weight of 2000 to 30000.

3) The polycarbonate resin composition described in 1) or 2), wherein, in the flowability enhancing agent, a portion, corresponding to R₁, of a structure derived from the dicarboxylic acid component (C) is a linear saturated aliphatic hydrocarbon chain.

4) The polycarbonate resin composition described in any one of 1) through 3), wherein, in the flowability enhancing agent, a portion, corresponding to R₁, of a structure derived from the dicarboxylic acid component (C) has even numbers of atoms in a skeleton of its main chain.

5) The polycarbonate resin composition described in any one of 1) through 4), wherein: terminals of the flowability enhancing agent are sealed with a monofunctional low molecular weight compound; and a rate of the terminals of the flowability enhancing agent, which terminals are sealed with the monofunctional low molecular weight compound, is not less than 50%.

6) A molded article obtained by molding a polycarbonate resin composition described in any one of 1) through 5).

### Advantageous Effects of Invention

A flowability enhancing agent in accordance with an aspect of the present invention makes it possible to provide (i) a polycarbonate resin composition containing a polycarbonate resin whose flowability during molding of the polycarbonate resin is enhanced without loss of inherent properties (for example, transparency, mechanical strength, and heat resistance) of the polycarbonate resin and (ii) a molded article obtained from the polycarbonate resin composition. Note that the term “loss” herein means that a property of a resin is deteriorated to such a degree that the property does not satisfy a level demanded for the property. That is, even in a case where some property of the polycarbonate resin is deteriorated by addition of the flowability enhancing agent in accordance with an aspect of the present invention, this does not mean that the polycarbonate resin has lost its inherent properties, provided that the inherent properties satisfy levels demanded for a purpose of use of the polycarbonate resin. Therefore, the above description can be rephrased as follows: “without substantial loss of inherent properties of a polycarbonate resin.”

The polycarbonate resin composition in accordance with an aspect of the present invention makes it possible to produce a molded article that is larger, thinner, and/or more complicated in shape.

### DESCRIPTION OF EMBODIMENTS

The following description will discuss an embodiment of the present invention. Note, however, that the present invention is not limited to such an embodiment. The present invention is not limited to arrangements described below, and may be altered in various ways by a skilled person within the scope of the claims. Any embodiment and/or example derived from a proper combination of technical means disclosed in different embodiments and/or examples are/is also encompassed in the technical scope of the present invention. All academic and patent literatures listed herein are incorporated herein by reference. Unless otherwise specified herein, a numerical range expressed as “A to B” means “not less than A and not more than B.”

A flowability enhancing agent in accordance with an embodiment of the present invention includes a polyester which is obtained through polycondensation of a bisphenol component and an aliphatic dicarboxylic acid component and, optionally, a biphenol component in specific proportions.

The flowability enhancing agent in accordance with an embodiment of the present invention includes, in its main chain structure, a polycondensate of a monomer mixture containing a biphenol component (A) in a proportion of 0 mol % to 55 mol %, a bisphenol component (B) in a proportion of 5 mol % to 60 mol %, and a dicarboxylic acid component (C) in a proportion of 40 mol % to 60 mol %, with respect to 100 mol % of a total amount of the biphenol component (A), the bisphenol component (B), and the dicarboxylic acid component (C),

the biphenol component (A) being represented by the following general formula (1):

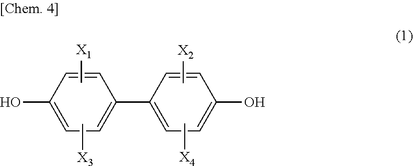

where X₁ through X₄ each independently represent a hydrogen atom, a halogen atom, or an alkyl group having 1 to 4 carbon atom(s) and may be identical to or different from each other,

the bisphenol component (B) being represented by the following general formula (2):

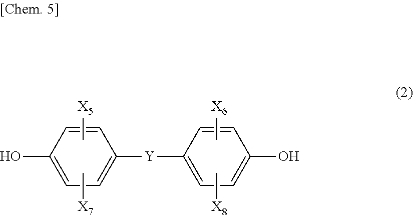

where: X₅ through X₈ each independently represent a hydrogen atom, a halogen atom, or an alkyl group having 1 to 4 carbon atom(s) and may be identical to or different from each other; Y represents a methylene group, an isopropylidene group, a cyclic alkylidene group, an aryl-substituted alkylidene group, an arylenedialkylidene group, —S—, —O—, a carbonyl group, or —SO₂—,

the dicarboxylic acid component (C) being represented by the following general formula (3):

HOOC—R₁—COOH (3)

where R₁ represents a divalent linear substituent which has 2 to 18 atoms in its main chain and which may contain a branch.

The flowability enhancing agent in accordance with an embodiment of the present invention includes a polyester produced through polycondensation of (i) a diol component made of the bisphenol component (B) and, optionally, the biphenol component (A) and (ii) the dicarboxylic acid component (C).

The flowability enhancing agent is not a low molecular weight compound. It is therefore possible to suppress occurrence of bleedout of the flowability enhancing agent while a polycarbonate resin composition containing the flowability enhancing agent is molded.

Furthermore, the flowability enhancing agent having the above-described molecular structure has high compatibility with a polycarbonate resin. It is therefore possible to efficiently enhance flowability of a resin composition obtained by adding the flowability enhancing agent to the polycarbonate resin, without loss of various inherent properties of the polycarbonate resin.

The flowability enhancing agent contains the biphenol component (A) in a proportion of preferably 0 mol % to 55 mol %, more preferably 10 mol % to 40 mol %, most preferably mol % to 30 mol %. The flowability enhancing agent contains the bisphenol component (B) in a proportion of preferably 5 mol % to 60 mol %, more preferably 10 mol % to mol %, most preferably 20 mol % to 30 mol %. The flowability enhancing agent contains the dicarboxylic acid component (C) in a proportion of preferably 40 mol % to 60 mol %, more preferably 45 mol % to 55 mol %.

In a case where the biphenol component (A) and the bisphenol component (B) are used as the diol component, a molar ratio ((A)/(B)) between the biphenol component (A) and the bisphenol component (B) is preferably 1/9 to 9/1, more preferably 1/7 to 7/1, still more preferably 1/5 to 5/1, and most preferably 1/3 to 3/1. In a case where the flowability enhancing agent contains the biphenol component (A) in a lower proportion so that the molar ratio (A)/(B) is less than 1/9, the polyester itself becomes completely amorphous, and a glass transition temperature of the flowability enhancing agent is lowered. This may cause fusion of pellets of the flowability enhancing agent during storage. In a case where the flowability enhancing agent contains the bisphenol component (B) in a lower proportion so that the molar ratio (A)/(B) is more than 9/1, the flowability enhancing agent has insufficient compatibility with the polycarbonate resin. In such a case, in a case where the resin composition, obtained by adding the flowability enhancing agent to the polycarbonate resin, is molded into a molded article having a thickness of not less than 4 mm, phase separation may occur in a central part of the thickness of the molded article while the molded article is slowly cooled. Accordingly, various physical properties of the polycarbonate resin may be deteriorated.

X₁ through X₄ in the general formula (1) each independently represent a hydrogen atom, a halogen atom, or an alkyl group having 1 to 4 carbon atom(s) and may be identical to or different from each other. It is more preferable that X₁ through X₄ be all hydrogen atoms, in order to enhance crystallinity of the flowability enhancing agent itself and to improve handleability of the flowability enhancing agent (e.g., prevent the pellets from being fused together during the storage).

X₅ through X₈ in the general formula (2) each independently represent a hydrogen atom, a halogen atom, or an alkyl group having 1 to 4 carbon atom(s) and may be identical to or different from each other. It is more preferable that X₅ through X₈ be all hydrogen atoms, in order to enhance the compatibility of the flowability enhancing agent with the polycarbonate resin. Y represents a methylene group, an isopropylidene group, a cyclic alkylidene group, an aryl-substituted alkylidene group, an arylenedialkylidene group, —S—, —O—, a carbonyl group, or —SO₂—.

As the bisphenol component represented by the general formula (2), 2,2-bis(4-hydroxyphenyl)propane [common name: bisphenol A] is particularly preferable in that such a bisphenol component causes the compatibility of the flowability enhancing agent with the polycarbonate resin to be enhanced. Examples of divalent phenol other than the bisphenol A include: bis(hydroxyaryl)alkanes such as bis(4-hydroxyphenyl)methane, 1,1-bis(4-hydroxyphenyl)ethane, 2,2-bis(4-hydroxyphenyl)butane, 2,2-bis(4-hydroxyphenyl)octane, 2,2-bis(4-hydroxy-1-methylphenyl)propane, 1,1-bis(4-hydroxy-t-butylphenyl)propane, 2,2-bis(4-hydroxy-3-bromophenyl)propane, 2,2-bis(4-hydroxy-3,5-dimethylphenyl)propane, 2,2-bis(4-hydroxy-3-chlorophenyl)propane, 2,2-bis(4-hydroxy-3,5-dichlorophenyl)propane, and 2,2-bis(4-hydroxy-3,5-dibromophenyl)propane; bis(hydroxyaryl)arylalkanes such as 2,2-bis(4-hydroxyphenyl)phenylmethane and bis(4-hydroxyphenyl)naphthylmethane; bis(hydroxyaryl)cycloalkanes such as 1,1-bis(4-hydroxyphenyl)cyclopentane, 1,1-bis(4-hydroxyphenyl)cyclohexane, and 1,1-bis(4-hydroxyphenyl)-3,5,5-trimethylcyclohexane; dihydroxyarylethers such as 4,4′-dihydroxyphenylether and 4,4′-dihydroxy-3,3′-dimethylphenylether; dihydroxydiarylsulfides such as 4,4′-dihydroxydiphenylsulfide and 4,4′-dihydroxy-3,3′-dimethyldiphenylsulfide; dihydroxydiarylsulfoxides such as 4,4′-dihydroxydiphenylsulfoxide and 4,4′-dihydroxy-3,3′-dimethyldiphenylsulfoxide; dihydroxydiarylsulfones such as 4,4′-dihydroxydiphenylsulfone and 4,4′-dihydroxy-3,3′-dimethyldiphenylsulfone; and dihydroxydiphenyls such as 4,4′-dihydroxydiphenyl. Each of these bisphenol components can be used solely. Alternatively, two or more of these bisphenol components can be used in combination, provided that the two or more of these bisphenol components do not cause the effect of the present invention to be lost.

A terminal structure of the flowability enhancing agent in accordance with an embodiment of the present invention is not particularly limited. However, it is preferable that terminals of the flowability enhancing agent be sealed with a monofunctional low molecular weight compound, particularly in order to (i) suppress transesterification of the flowability enhancing agent with the polycarbonate resin so as to suppress yellowing of the resin composition obtained by adding the flowability enhancing agent to the polycarbonate resin and (ii) suppress hydrolysis between the flowability enhancing agent and the polycarbonate resin so as to ensure long-term stability.

A sealing rate with respect to all terminals of a molecular chain is preferably not less than 50%, more preferably not less than 70%, still more preferably not less than 80%, and most preferably not less than 90%.

A terminal sealing rate of the flowability enhancing agent can be determined by (i) measuring the number of sealed terminal functional groups and the number of unsealed terminal functional groups and (ii) substituting these numbers into the following expression (5). As a specific method for calculating the terminal sealing rate, a method in which (i) each of the number of sealed terminal functional groups and the number of unsealed terminal functional groups is determined from an integral value of a characteristic signal corresponding to the each of the number of sealed terminal functional groups and the number of unsealed terminal functional groups with use of ¹H-NMR and (ii) the terminal sealing rate is calculated, based on a result of such determination, with use of the following expression (5) is preferable in view of accuracy and simplicity.

Terminal sealing rate (%)={[the number of sealed terminal functional groups]/([the number of sealed terminal functional groups]+[the number of unsealed terminal functional groups])}×100 (5)

Examples of the monofunctional low molecular weight compound used for sealing include monovalent phenol, monoamine having 1 to 20 carbon atom(s), aliphatic monocarboxylic acid, carbodiimide, epoxy, and oxazoline. Specific examples of the monovalent phenol include phenol, p-cresol, p-t-butylphenol, p-t-octylphenol, p-cumylphenol, p-nonylphenol, p-t-amylphenol, 4-hydroxybiphenyl, and any mixture of such monovalent phenols. Of these monovalent phenols, p-t-butylphenol and p-cumylphenol are preferable in view of easiness of polymerization at a high boiling point. Specific examples of the aliphatic monocarboxylic acid include: aliphatic monocarboxylic acids such as acetic acid, propionic acid, butyric acid, valeric acid, caproic acid, caprylic acid, lauric acid, tridecanoic acid, myristic acid, palmitic acid, stearic acid, pivalic acid, and isobutyric acid; and any mixture of such aliphatic monocarboxylic acids. Of these aliphatic monocarboxylic acids, myristic acid, palmitic acid, and stearic acid are preferable in view of easiness of polymerization at a high boiling point. Specific examples of the monoamine include: aliphatic monoamines such as methylamine, ethylamine, propylamine, butylamine, hexylamine, octylamine, decylamine, stearylamine, dimethylamine, diethylamine, dipropylamine, and dibutylamine; and any mixture of such monoamines. Examples of the carbodiimide include dicyclohexylcarbodiimide, diisopropylcarbodiimide, dimethylcarbodiimide, diisobutylcarbodiimide, dioctylcarbodiimide, t-butylisopropylcarbodiimide, diphenylcarbodiimide, di-t-butylcarbodiimide, di-p-naphthylcarbodiimide, bis-2,6-diisopropylphenylcarbodiimide, poly(2,4,6-triisopropylphenylene-1,3-diisocyanate), 1,5-(diisopropylbenzene)polycarbodiimide, 2,6,2′,6′-tetraisopropyldiphenylcarbodiimide, and any mixture of such carbodiimides. Examples of the epoxy include ethylene glycol diglycidyl ether, propylene glycol diglycidyl ether, neopentyl glycol diglycidyl ether, triethylolpropane polyglycidyl ether, glycerol diglycidyl ether, glycerol triglycidyl ether, sorbitol polyglycidyl ether, bisphenol A-diglycidyl ether, hydrogenated bisphenol A-glycidyl ether, 4,4′-diphenyl methane diglycidyl ether, terephthalic acid diglycidyl ester, isophthalic acid diglycidyl ester, methacrylic acid glycidyl ester, methacrylic acid glycidyl ester polymer, a methacrylic acid glycidyl ester polymer containing compound, and any mixture of such epoxies. Examples of the oxazoline include styrene.2-isopropenyl-2-oxazoline, 2-isopropenyl-2-oxazoline, 1,3-phenylenebis(2-oxazoline), and a mixture thereof.

R₁ in the following general formula (3) representing the component (C) represents a divalent linear substituent which has 2 to 18 atoms in its main chain and which may contain a branch.

HOOC—R₁—COOH (3)

Here, the number of atoms in the main chain is the number of atoms in a skeleton of the main chain. For example, in a case where —R₁— is —(CH₂)₈—, the number of atoms in the main chain is 8, which is the number of carbon atoms. R₁ is preferably a linear substituent which does not contain a branch, and more preferably a linear aliphatic hydrocarbon chain which does not contain a branch. This is because a melt viscosity of the flowability enhancing agent itself is decreased. Further, R₁ may be saturated or unsaturated, but is preferably a saturated aliphatic hydrocarbon chain. In a case where R₁ contains an unsaturated bond, the flowability enhancing agent may not have sufficient flexibility. This may cause an increase in the melt viscosity of the flowability enhancing agent itself. In view of achievement of both of (i) easiness of polymerization of the flowability enhancing agent and (ii) an increase in the glass transition point of the flowability enhancing agent, R₁ is preferably a linear saturated aliphatic hydrocarbon chain having 2 to 18 carbon atoms, more preferably a linear saturated aliphatic hydrocarbon chain having 4 to 16 carbon atoms, still more preferably a linear saturated aliphatic hydrocarbon chain having 8 to 14 carbon atoms, and most preferably a linear saturated aliphatic hydrocarbon chain having 8 carbon atoms. The increase in the glass transition point of the flowability enhancing agent causes enhancement of heat resistance of the resin composition obtained by adding the flowability enhancing agent to the polycarbonate resin. In view of a decrease in the melt viscosity of the flowability enhancing agent itself, the number of atoms in the main chain of R₁ is preferably an even number. In view the above, R₁ is particularly preferably one selected from —(CH₂)₈—, —(CH₂)₁₀— and —(CH₂)₁₂—.

The flowability enhancing agent in accordance with an embodiment of the present invention can be copolymerized with another monomer, provided that such a copolymerization does not cause the effect of the flowability enhancing agent to be lost. Examples of the another monomer include aromatic hydroxycarboxylic acid, aromatic dicarboxylic acid, aromatic diol, aromatic hydroxyamine, aromatic diamine, aromatic aminocarboxylic acid, caprolactams, caprolactones, aliphatic dicarboxylic acid, aliphatic diol, aliphatic diamine, alicyclic dicarboxylic acid, alicyclic diol, aromatic mercaptocarboxylic acid, aromatic dithiol, and aromatic mercaptophenol.

Note, however, that the flowability enhancing agent contains the another monomer in a proportion of less than 50 mol %, preferably less than 30 mol %, more preferably less than 10 mol %, most preferably less than 5 mol %, with respect to the number of moles of the entire flowability enhancing agent. In a case where the flowability enhancing agent contains the another monomer in a proportion of not less than 50 mol % with respect to the number of moles of the entire flowability enhancing agent, the compatibility of the flowability enhancing agent with the polycarbonate resin is deteriorated, and it becomes difficult to cause the flowability enhancing agent to be compatible with the polycarbonate resin.

Specific examples of the aromatic hydroxycarboxylic acid include 4-hydroxybenzoic acid, 3-hydroxybenzoic acid, 2-hydroxybenzoic acid, 2-hydroxy-6-naphthoic acid, 2-hydroxy-5-naphthoic acid, 2-hydroxy-7-naphthoic acid, 2-hydroxy-3-naphthoic acid, 4′-hydroxyphenyl-4-benzoic acid, 3′-hydroxyphenyl-4-benzoic acid, and 4′-hydroxyphenyl-3-benzoic acid, each of which may or may not be substituted with alkyl, alkoxy, or halogen.

Specific examples of the aromatic dicarboxylic acid include terephthalic acid, isophthalic acid, 2,6-naphthalenedicarboxylic acid, 1,6-naphthalenedicarboxylic acid, 2,7-naphthalenedicarboxylic acid, 4,4′-dicarboxybiphenyl, 3,4′-dicarboxybiphenyl, 4,4″-dicarboxyterphenyl, bis(4-carboxyphenyl)ether, bis(4-carboxyphenoxy)butane, bis(4-carboxyphenyl)ethane, bis(3-carboxyphenyl)ether, and bis(3-carboxyphenyl)ethane, each of which may or may not be substituted with alkyl, alkoxy, or halogen.

Specific examples of the aromatic diol include pyrocatechol, hydroquinone, resorcin, 2,6-dihydroxynaphthalene, 2,7-dihydroxynaphthalene, 1,6-dihydroxynaphthalene, 3,3′-dihydroxybiphenyl, 3,4′-dihydroxybiphenyl, 4,4′-dihydroxybiphenyl, 4,4′-dihydroxybiphenol ether, bis(4-hydroxyphenyl)ethane, and 2,2′-dihydroxybinaphthyl, each of which may or may not be substituted with alkyl, alkoxy, or halogen.

Specific examples of the aromatic hydroxylamine include 4-aminophenol, N-methyl-4-aminophenol, 3-aminophenol, 3-methyl-4-aminophenol, 4-amino-1-naphthol, 4-amino-4′-hydroxybiphenyl, 4-amino-4′-hydroxybiphenyl ether, 4-amino-4′-hydroxybiphenyl methane, 4-amino-4′-hydroxybiphenyl sulfide, and 2,2′-diaminobinaphthyl, each of which may or may not be substituted with alkyl, alkoxy, or halogen.

Specific examples of the aromatic diamine and the aromatic aminocarboxylic acid include 1,4-phenylenediamine, 1,3-phenylenediamine, N-methyl-1,4-phenylenediamine, N,N′-dimethyl-1,4-phenylenediamine, 4,4′-diaminophenyl sulfide (thiodianiline), 4,4′-diaminobiphenyl sulfone, 2,5-diaminotoluene, 4,4′-ethylenedianiline, 4,4′-diaminobiphenoxyethane, 4,4′-diaminobiphenyl methane (methylenedianiline), 4,4′-diaminobiphenyl ether (oxydianiline), 4-aminobenzoic acid, 3-aminobenzoic acid, 6-amino-2-naphthoic acid, and 7-amino-2-naphthoic acid, each of which may or may not be substituted with alkyl, alkoxy, or halogen.

Specific examples of the aliphatic dicarboxylic acid include oxalic acid, malonic acid, succinic acid, glutaric acid, adipic acid, pimelic acid, suberic acid, azelaic acid, sebacic acid, dodecanedioic acid, tetradecanedioic acid, fumaric acid, and maleic acid.

Specific examples of the aliphatic diamine include 1,2-ethylenediamine, 1,3-trimethylenediamine, 1,4-tetramethylenediamine, 1,6-hexamethylenediamine, 1,8-octanediamine, 1,9-nonanediamine, 1,10-decanediamine, and 1,12-dodecanediamine.

Specific examples of the alicyclic dicarboxylic acid, the aliphatic diol, and the alicyclic diol include: linear or branched aliphatic diols such as hexahydroterephthalic acid, trans-1,4-cyclohexanediol, cis-1,4-cyclohexanediol, trans-1,4-cyclohexanedimethanol, cis-1,4-cyclohexanedimethanol, trans-1,3-cyclohexanediol, cis-1,2-cyclohexanediol, trans-1,3-cyclohexanedimethanol, ethylene glycol, propylene glycol, butylene glycol, 1,3-propanediol, 1,2-propanediol, 1,4-butanediol, 1,6-hexanediol, 1,8-octanediol, 1,10-decanediol, 1,12-dodecanediol, and neopentyl glycol; and reactive derivatives of such diols.

Specific examples of the aromatic mercaptocarboxylic acid, the aromatic dithiol, and the aromatic mercaptophenol include 4-mercaptobenzoic acid, 2-mercapto-6-naphthoic acid, 2-mercapto-7-naphthoic acid, benzene-1,4-dithiol, benzene-1,3-dithiol, 2,6-naphthalene-dithiol, 2,7-naphthalene-dithiol, 4-mercaptophenol, 3-mercaptophenol, 6-mercapto-2-hydroxynaphthalene, 7-mercapto-2-hydroxynaphthalene, and reactive derivatives of such compounds.

The flowability enhancing agent in accordance with an embodiment of the present invention can contain, in advance, a phosphite antioxidant so that the resin composition having a good color tone can be obtained. [Note, here, that the flowability enhancing agent containing, in advance, the phosphite antioxidant means a mixture of the phosphite antioxidant and the flowability enhancing agent. The phosphite antioxidant functions as an antioxidant also in the resin composition. That is, although the most simple method for producing the resin composition in accordance with an embodiment of the present invention is a method in which three components, i.e., the polycarbonate resin, the flowability enhancing agent, and the phosphite antioxidant are mixed together at a time, the present invention also encompasses, as an embodiment, mixing “the polycarbonate resin” and “the mixture of the phosphite antioxidant and the flowability enhancing agent” together.]

Reasons why the resin composition having a good color tone can be obtained are as follows. That is, it is considered that the phosphite antioxidant (i) prevents discoloration of the flowability enhancing agent itself and (ii) deactivates a polymerization catalyst used for the polymerization by which the flowability enhancing agent is obtained, thereby preventing discoloration of the resin composition due to transesterification or a hydrolysis reaction between the polyester, included in the flowability enhancing agent, and the polycarbonate resin which transesterification or hydrolysis reaction may occur when the flowability enhancing agent and the polycarbonate resin are mixed together. This makes it possible to effectively suppress a reduction in a molecular weight of the polycarbonate resin and, accordingly, makes it possible to enhance merely the flowability of the resin composition containing the flowability enhancing agent, without loss of the inherent properties of the polycarbonate resin. The flowability enhancing agent contains the phosphite antioxidant in an amount of preferably 0.005% by mass to 5% by mass, more preferably 0.01% by mass to 2% by mass, still more preferably 0.01% by mass to 1% by mass, and most preferably 0.02% by mass to 0.5% by mass, with respect to a weight of the flowability enhancing agent. In a case where the flowability enhancing agent contains the phosphite antioxidant in an amount of less than 0.005% by mass, the amount of the phosphite antioxidant is small and, accordingly, coloring may occur when the flowability enhancing agent is added to the polycarbonate resin. In a case where the flowability enhancing agent contains the phosphite antioxidant in an amount of more than 5% by mass, impact strength of the resin composition obtained by adding the flowability enhancing agent to the polycarbonate resin may be deteriorated.

As the phosphite antioxidant, various compounds are known. For example, various compounds are described in “Sanka Boshizai Handobukku (Antioxidant Handbook)” published by Taiseisha, “Kobunshizairyo no Rekka to Anteika (Degradation and Stabilization of Polymer Material)” (pages 235 to 242) published by CMC Publishing Co., Ltd., and the like. However, the phosphite antioxidant is not limited to these compounds. Examples of the phosphite antioxidant include tris(2,4-di-t-butylphenyl)phosphite, bis[2,4-bis(1,1-dimethylethyl)-6-methylphenyl]ethyl ester phosphorous acid, bis(2,4-di-t-butylphenyl)pentaerythritol diphosphite, bis(2,4-dicumylphenyl)pentaerythritol diphosphite, and bis(2,6-di-t-butyl-4-methylphenyl) pentaerythritol-di-phosphite. Examples of product names include: ADK STAB PEP-36, ADK STAB PEP-4C, ADK STAB PEP-8, ADK STAB PEP-8F, ADK STAB PEP-8W, ADK STAB PEP-11C, ADK STAB PEP-24G, ADK STAB HP-10, ADK STAB 2112, ADK STAB 260, ADK STAB P, ADK STAB QL, ADK STAB 522A, ADK STAB 329K, ADK STAB 1178, ADK STAB 1500, ADK STAB C, ADK STAB 135A, ADK STAB 3010, and ADK STAB TPP (each manufactured by ADEKA Corporation); and Irgafos 38, Irgafos 126, Irgafos 168, and Irgafos P-EPQ (each manufactured by BASF Japan Ltd.). Of these phosphite antioxidants, in particular, ADK STAB PEP-36, ADK STAB HP-10, ADK STAB 2112, ADK STAB PEP-24G, Irgafos 126, and the like are more preferable, because, for example, (i) such phosphite antioxidants can remarkably exhibit an effect of suppressing a transesterification reaction and the hydrolysis reaction and (ii) such phosphite antioxidants themselves have a high melting point and, accordingly, do not easily volatilize from a resin.

The flowability enhancing agent in accordance with an embodiment of the present invention can contain, in advance, a hindered phenol antioxidant so that the polycarbonate resin composition having a good color tone can be obtained. The flowability enhancing agent contains the hindered phenol antioxidant in an amount of preferably 0.005% by mass to 5% by mass, more preferably 0.01% by mass to 2% by mass, still more preferably 0.01% by mass to 1% by mass, and most preferably 0.02% by mass to 0.5% by mass, with respect to the weight of the flowability enhancing agent. In a case where the flowability enhancing agent contains the hindered phenol antioxidant in an amount of less than 0.005% by mass, the amount of the hindered phenol antioxidant is small and, accordingly, coloring may occur when the flowability enhancing agent is added to the polycarbonate resin. In a case where the flowability enhancing agent contains the hindered phenol antioxidant in an amount of more than 5% by mass, the impact strength of the resin composition obtained by adding the flowability enhancing agent to the polycarbonate resin may be deteriorated.

Examples of the hindered phenol antioxidant include 2,6-di-t-butyl-4-methylphenol, 2,6-di-t-butyl-4-ethylphenol, mono (or di, or tri) (α-methylbenzyl)phenol, 2,2′-methylenebis(4-ethyl-6-t-butylphenol), 2,2′-methylenebis(4-methyl-6-t-butylphenol), 4,4′-butylidenebis(3-methyl-6-t-butylphenol), 4,4′-thiobis(3-methyl-6-t-butylphenol), 2,5-di-t-butylhydroquinone, 2,5-di-t-amylhydroquinone, triethylene glycol-bis-[3-(3-t-butyl-5-methyl-4-hydroxyphenyl)propionate], 1,6-hexanediol-bis[3-(3,5-di-t-butyl-4-hydroxyphenyl)propionate], 2,4-bis-(n-octylthio)-6-(4-hydroxy-3,5-di-t-butylanilino)-1,3,5-triazine, pentaerythritol-tetrakis[3-(3,5-di-t-butyl-4-hydroxyphenyl)propionate], 2,2-thio-diethylene bis[3-(3,5-di-t-butyl-4-hydroxyphenyl)propionate], octadecyl-3-(3,5-di-t-butyl-4-hydroxyphenyl)propionate, N,N′-hexamethylenebis(3,5-di-t-butyl-4-hydroxy-hydrocinnamamide), 3,5-di-t-butyl-4-hydroxy-benzylphosphonate-diethyl ester, 1,3,5-trimethyl-2,4,6-tris(3,5-di-t-butyl-4-hydroxybenzyl)benzene, calcium bis(ethyl 3,5-di-t-butyl-4-hydroxybenzylphosphonate), tris-(3,5-di-t-butyl-4-hydroxybenzyl)isocyanurate, 2,4-bis[(octylthio) methyl]o-cresol, N,N′-bis[3-(3,5-di-t-butyl-4-hydroxyphenyl)propionyl]hydrazine, tris(2,4-di-t-butylphenyl)phosphite, 2-(5-methyl-2-hydroxyphenyl)benzotriazole, 2-[2-hydroxy-3,5-bis(α,α-dimethylbenzyl)phenyl]-2H-benzotriazole, 2-(3,5-di-t-butyl-2-hydroxyphenyl)benzotriazole, 2-(3-t-butyl-5-methyl-2-hydroxyphenyl)-5-chlorobenzotriazole, 2-(3,5-di-t-butyl-2-hydroxyphenyl)-5-chlorobenzotriazole, 2-(3,5-di-t-amyl-2-hydroxyphenyl)benzotriazole, 2-(2′-hydroxy-5′-t-octylphenyl)-benzotriazole, a condensate of methyl-3-[3-t-butyl-5-(2H-benzotriazol-2-yl)-4-hydroxyphenyl]propionate and polyethylene glycol (having a molecular weight of about 300), hydroxyphenylbenzotriazole derivatives, 2-(3,5-di-t-butyl-4-hydroxybenzyl)-2-n-butyl malonate bis(1,2,2,6,6-pentamethyl-4-piperidyl), and 2,4-di-t-butylphenyl-3,5-di-t-butyl-4-hydroxybenzoate.

Examples of product names include: NOCRAC 200, NOCRAC M-17, NOCRAC SP, NOCRAC SP-N, NOCRAC NS-5, NOCRAC NS-6, NOCRAC NS-30, NOCRAC 300, NOCRAC NS-7, and NOCRAC DAH (each manufactured by Ouchi Shinko Chemical Industrial Co., Ltd.); ADK STAB AO-30, ADK STAB AO-40, ADK STAB AO-50, ADK STAB AO-60, ADK STAB AO-616, ADK STAB AO-635, ADK STAB AO-658, ADK STAB AO-80, ADK STAB AO-15, ADK STAB AO-18, ADK STAB 328, ADK STAB AO-330, and ADK STAB AO-37 (each manufactured by ADEKA Corporation); IRGANOX-245, IRGANOX-259, IRGANOX-565, IRGANOX-1010, IRGANOX-1024, IRGANOX-1035, IRGANOX-1076, IRGANOX-1081, IRGANOX-1098, IRGANOX-1222, IRGANOX-1330, and IRGANOX-1425WL (each manufactured by BASF Japan Ltd.); and Sumilizer GA-80 (manufactured by Sumitomo Chemical Co., Ltd.). Of these hindered phenol antioxidants, ADK STAB AO-60, ADK STAB AO-330, IRGANOX-1010, and the like are more preferable, because (i), in particular, such hindered phenol antioxidants themselves do not easily discolor and (ii) use of such hindered phenol antioxidants in combination with the phosphite antioxidant allows coloring of a resin to be efficiently suppressed.

Further, as a phenol antioxidant, a monoacrylate phenol stabilizer having both an acrylate group and a phenol group can be also used. Examples of the monoacrylate phenol stabilizer include 2-t-butyl-6-(3-t-butyl-2-hydroxy-5-methylbenzyl)-4-methylphenyl acrylate (product name: Sumilizer GM) and 2,4-di-t-amyl-6-[1-(3,5-di-t-amyl-2-hydroxyphenyl)ethyl]phenyl acrylate (product name: Sumilizer GS).

As a combination of the phosphite antioxidant and the hindered phenol antioxidant, a combination of (i) ADK STAB 2112, ADK STAB PEP-36, and Irgafos 126 and (ii) ADK STAB AO-60, ADK STAB AO-330, and IRGANOX-1010 is preferable because such a combination allows coloring of a resin to be particularly suppressed.

A number average molecular weight of the flowability enhancing agent in accordance with an embodiment of the present invention is a value measured by GPC at 80° C. with use of (i) polystyrene as a standard substance and (ii) a solution prepared by dissolving the resin, that is, the flowability enhancing agent in accordance with an embodiment of the present invention in a mixed solvent, containing p-chlorophenol and toluene at a volume ratio of 3:8, such that a concentration of the resin, that is, the flowability enhancing agent is 0.25% by mass. The flowability enhancing agent in accordance with an embodiment of the present invention has a number average molecular weight of preferably 2000 to 30000, more preferably 3000 to 20000, and still more preferably 4000 to 15000. In a case where the flowability enhancing agent has a number average molecular weight of less than 2000, the flowability enhancing agent may bleed out when, for example, the resin composition obtained by adding the flowability enhancing agent to the polycarbonate resin is molded. In a case where the flowability enhancing agent has a number average molecular weight of more than 30000, the melt viscosity of the flowability enhancing agent itself is high, and it may not be possible to effectively enhance the flowability of the resin composition, obtained by adding the flowability enhancing agent to the polycarbonate resin, during molding of the resin composition.

The flowability enhancing agent in accordance with an embodiment of the present invention can be produced by any publicly known method. One example of a method for producing the flowability enhancing agent is a method in which hydroxyl groups of monomers and a terminal sealing agent are each individually or collectively converted to lower fatty acid ester with use of lower fatty acid such as acetic anhydride and then lower fatty acid-eliminating polycondensation reactions between the lower fatty acid ester and carboxylic acid are carried out in separate reaction vessels or in an identical reaction vessel. The polycondensation reaction is carried out in a state in which no solvent is substantially present, at a temperature of usually 220° C. to 330° C. and preferably 240° C. to 310° C., in the presence of an inert gas such as a nitrogen gas, under an ordinary pressure or a reduced pressure, for 0.5 hours to 5 hours. In a case where a reaction temperature is lower than 220° C., the polycondensation reaction progresses slowly. In a case where the reaction temperature is higher than 330° C., a side reaction such as decomposition is likely to occur. In a case where the polycondensation reaction is carried out under the reduced pressure, it is preferable to reduce a pressure stepwise. In a case where the pressure is rapidly reduced so that a degree of vacuum becomes high, the dicarboxylic acid monomer or the low molecular weight compound, which is used to seal the terminals, volatilizes and, accordingly, it may not be possible to obtain a resin having a desired composition or a desired molecular weight. An ultimate degree of vacuum is preferably not more than 40 Torr, more preferably not more than 30 Torr, still more preferably not more than 20 Torr, and particularly preferably not more than 10 Torr. In a case where the ultimate degree of vacuum is higher than 40 Torr, acid elimination does not proceed sufficiently. This may cause polymerization time to be longer, thereby causing the resin to be colored. The polycondensation reaction can be carried out at multi-stage reaction temperatures. Alternatively, in some cases, the polycondensation reaction can be carried out in such a manner that a reaction product in a melted state is taken out and collected while the reaction temperature is increasing or immediately after the reaction temperature reaches a maximum temperature. A polyester resin thus obtained can be used as it is, or can be alternatively used after removal of an unreacted raw material or after being subjected to solid phase polymerization so as to improve physical properties of the polyester resin. In a case where the solid phase polymerization is carried out, it is preferable that (i) the polyester resin thus obtained be mechanically crushed into particles having a particle diameter of not more than 3 mm, preferably not more than 1 mm and then (ii) the particles of the polyester resin in a solid-phase state be processed for 1 hour to 30 hours at a temperature of 100° C. to 350° C. under an atmosphere of an inert gas, such as nitrogen, or under a reduced pressure. It is not preferable that the particles of the polyester resin have a particle diameter of more than 3 mm, because a sufficient process is not carried out and a problem occurs with the physical properties. It is preferable that a processing temperature and a rate of temperature increase during the solid phase polymerization be selected such that fusion of the particles of the polyester resin does not occur.

Examples of an acid anhydride of the lower fatty acid used to produce the flowability enhancing agent in accordance with an embodiment of the present invention include acid anhydrides of lower fatty acids having 2 to 5 carbon atoms, such as acetic anhydride, propionic anhydride, monochloroacetic anhydride, dichloroacetic anhydride, trichloroacetic anhydride, monobromoacetic anhydride, dibromoacetic anhydride, tribromoacetic anhydride, monofluoroacetic anhydride, difluoroacetic anhydride, trifluoroacetic anhydride, butyric anhydride, isobutyric anhydride, valeric anhydride, and pivalic anhydride. Of these acid anhydrides, acetic anhydride, propionic anhydride, and trichloroacetic anhydride are suitably used. The acid anhydride of the lower fatty acid is used in an amount of 1.01 equivalents to 1.5 equivalents, and preferably 1.02 equivalents to 1.2 equivalents, with respect to a sum of functional groups, such as hydroxyl groups, of the monomers and the terminal sealing agent to be used. In a case where the acid anhydride of the lower fatty acid is used in an amount of less than 1.01 equivalents, the acid anhydride of the lower fatty acid volatilizes and, accordingly, the functional groups such as hydroxyl groups may insufficiently react with an anhydride of the lower fatty acid, so that a resin having a low molecular weight may be obtained.

A polymerization catalyst can be used to produce the flowability enhancing agent in accordance with an embodiment of the present invention. As the polymerization catalyst, a catalyst conventionally publicly known as a polymerization catalyst for polyester can be used. Examples of the polymerization catalyst include: metal salt catalysts such as magnesium acetate, stannous acetate, tetrabutyl titanate, lead acetate, sodium acetate, potassium acetate, and antimony trioxide; and organic compound catalysts such as N,N-dimethylaminopyridine and N-methyl imidazole. Of these polymerization catalysts, sodium acetate, potassium acetate, and magnesium acetate are more preferable, because such polymerization catalysts allow (i) discoloration of the flowability enhancing agent itself to be prevented and (ii) discoloration of the polycarbonate resin composition to be prevented.

An amount of the polymerization catalyst is usually 0% by mass to 100×10⁻²% by mass, preferably 0.5×10⁻³% by mass to 50×10⁻²% by mass, with respect to a total weight of the polyester resin.

The flowability enhancing agent in accordance with an embodiment of the present invention is not limited to any particular shape or form. For example, the flowability enhancing agent can have a pellet-like, flake-like, or powder-like shape or form. A particle diameter of the flowability enhancing agent only needs to be so small that the flowability enhancing agent can be introduced into an extruder in which the flowability enhancing agent is melted and kneaded with the polycarbonate resin, and is preferably not more than 6 mm.

The resin composition in accordance with an embodiment of the present invention is made of the flowability enhancing agent, a polycarbonate oligomer, and the polycarbonate resin.

The resin composition contains the polycarbonate resin in a proportion of 60% by mass to 98.9% by mass, the polycarbonate oligomer in a proportion of 1% by mass to 10% by mass, and the flowability enhancing agent in accordance with an embodiment of the present invention in a proportion of 0.1% by mass to 30% by mass. The resin composition contains the flowability enhancing agent in a proportion of more preferably not less than 0.5% by mass, still more preferably not less than 1% by mass, and particularly preferably not less than 3% by mass (with respect to 100% by mass of the resin composition). The resin composition contains the flowability enhancing agent in a proportion of more preferably not more than 30% by mass, still more preferably not more than 10% by mass, and particularly preferably not more than 5% by mass (with respect to 100% by mass of the resin composition). In a case where the resin composition contains the flowability enhancing agent in a proportion of not less than 0.1% by mass (with respect to 100% by mass of the resin composition), the resin composition has enhanced flowability during the molding. In a case where the resin composition contains the flowability enhancing agent in a proportion of not more than 30% by mass (with respect to 100% by mass of the resin composition), heat resistance and mechanical physical properties of the polycarbonate resin are not considerably deteriorated. The flowability enhancing agent in accordance with an embodiment of the present invention has a glass transition temperature lower than that of the polycarbonate resin. Therefore, the flowability enhancing agent causes a decrease in a glass transition point of the resin composition obtained by causing the flowability enhancing agent to be compatible with the polycarbonate resin. Accordingly, in a case where the resin composition is caused to contain the flowability enhancing agent in accordance with an embodiment of the present invention in a proportion of more than 30% by mass, the heat resistance of the resin composition obtained may be deteriorated.

The resin composition contains the polycarbonate oligomer in a proportion of preferably 1% by mass to 10% by mass and more preferably 3% by mass to 8% by mass (with respect to 100% by mass of the resin composition). In a case where the resin composition contains the polycarbonate oligomer in a proportion of less than 1% by mass (with respect to 100% by mass of the resin composition), the flowability of the resin composition may not be effectively enhanced. In a case where the resin composition contains the polycarbonate oligomer in a proportion of more than 10% by mass (with respect to 100% by mass of the resin composition), strength of the resin composition may be deteriorated, so that the resin composition may not be able to achieve both the flowability and the impact strength.

The polycarbonate oligomer is an oligomer having a structural unit represented by the following general formula (4):

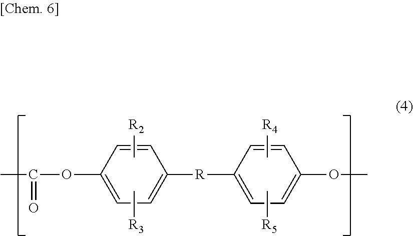

where: R represents a linear, branched, or cyclic alkylidene group having 1 to 10 carbon atom(s), an aryl-substituted alkylidene group, an arylenedialkylidene group, an oxygen atom, a sulfur atom, a carbonyl group, or a sulfonyl group; and R₂ through R₅ each independently represent a hydrogen atom, a halogen atom, or an alkyl or alkenyl group having 1 to 4 carbon atom(s) and may be identical to or different from each other.

The average number of repetitions of the structural unit is 2 to 15, and preferably 4 to 12. In a case where the average number of repetitions of the structural unit is not more than 2, the polycarbonate oligomer may bleed out while the resin composition, containing the polycarbonate oligomer having a low molecular weight, is molded. In a case where the average number of repetitions of the structural unit is not less than 15, it may not be possible to cause the polycarbonate resin composition to ensure sufficient flowability when the polycarbonate oligomer is added to the polycarbonate resin.

R in the general formula (4) represents a linear, branched, or cyclic alkylidene group having 1 to 10 carbon atom(s), an aryl-substituted alkylidene group, an arylenedialkylidene group, an oxygen atom, a sulfur atom, a carbonyl group, or a sulfonyl group. R₂ through R₅ each independently represent a hydrogen atom, a halogen atom, or an alkyl or alkenyl group having 1 to 4 carbon atom(s) and may be identical to or different from each other. It is preferable that R be an isopropylidene group and R₂ through R₅ be all hydrogen atoms, in order to effectively enhance the flowability in a case where the polycarbonate oligomer is added to the polycarbonate resin. As the polycarbonate oligomer, one kind of polycarbonate oligomer can be used solely. Alternatively, two or more kinds of polycarbonate oligomers can be used in combination.

The polycarbonate resin has a viscosity average molecular weight (Mv) of not less than 15,000 and more preferably not less than 22,000. In a case where the polycarbonate resin has a viscosity average molecular weight of not less than 15,000, the resin composition has good impact strength. The polycarbonate resin is not limited to any particular structure, and can be any of polycarbonate resins having various structural units. For example, the polycarbonate resin can be a polycarbonate resin produced by a method in which divalent phenol and carbonyl halide are subjected to interfacial polycondensation, a method in which divalent phenol and carbonic acid diester are subjected to melt polymerization (transesterification), or the like.

Examples of the divalent phenol, which is a raw material of the polycarbonate resin, include 4,4′-dihydroxybiphenyl, bis(4-hydroxyphenyl)methane, 1,1-bis(4-hydroxyphenyl)ethane, 2,2-bis(4-hydroxyphenyl)propane, 2,2-bis(3-methyl-4-hydroxyphenyl)propane, 2,2-bis(3,5-dimethyl-4-hydroxyphenyl)propane, 1,1-bis(4-hydroxyphenyl)cyclohexane, bis(4-hydroxyphenyl)ether, bis(4-hydroxyphenyl)sulfide, bis(4-hydroxyphenyl)sulfone, bis(4-hydroxyphenyl)sulfoxide, bis(4-hydroxyphenyl)ketone, hydroquinone, resorcin, and catechol. Of these divalent phenols, bis(hydroxyphenyl)alkanes are preferable, and divalent phenols obtained with use of 2,2-bis(4-hydroxyphenyl)propane as a main raw material are particularly preferable. Further, examples of a carbonate precursor include carbonyl halide, carbonyl ester, and haloformate. Specific examples include phosgene; diaryl carbonates such as divalent phenol dihaloformate, diphenyl carbonate, ditolyl carbonate, bis(chlorophenyl)carbonate, and m-cresyl carbonate; and aliphatic carbonate compounds such as dimethyl carbonate, diethyl carbonate, diisopropyl carbonate, dibutyl carbonate, diamyl carbonate, and dioctyl carbonate.

The polycarbonate resin can be a resin having a polymer chain whose molecular structure is a linear structure or can be alternatively a resin having a polymer chain whose molecular structure includes both a linear structure and a branched structure. Examples of a branching agent for introducing such a branched structure include 1,1,1-tris(4-hydroxyphenyl)ethane, α,α′,α″-tris(4-hydroxyphenyl)-1,3,5-triisopropylbenzene, phloroglucin, trimellitic acid, and isatinbis(o-cresol). Further, as a molecular weight regulator, phenol, p-t-butylphenol, p-t-octylphenol, p-cumylphenol, or the like can be used.

The polycarbonate resin used in an embodiment of the present invention can be a homopolymer produced with use of only the divalent phenol, can be alternatively a copolymer having a polycarbonate structural unit and a polyorganosiloxane structural unit, or can be alternatively a resin composition obtained from such a homopolymer and a copolymer. Alternatively, the polycarbonate resin can be a polyester-polycarbonate resin obtained by carrying out a polymerization reaction of divalent phenol and the like in the presence of bifunctional carboxylic acid (such as terephthalic acid) or an ester precursor thereof (such as an ester forming derivative). Further, a resin composition obtained by melting and kneading polycarbonate resins having various structural units can be also used.

As a component other than the polycarbonate resin, the polycarbonate oligomer, and the flowability enhancing agent, any other component such as an additive (e.g., a reinforcer, a thickener, a mold release, a coupling agent, a flame retarder, a flame-resistant agent, a pigment, a coloring agent, a light diffusing agent, an inorganic filler, and the other auxiliary agents) or a filler can be added to the resin composition in accordance with an embodiment of the present invention, depending on a purpose, provided that the effect of the present invention is not lost. These additives are preferably used in an amount of 0 parts by weight to 100 parts by weight in total with respect to 100 parts by weight of the resin composition obtained by blending the polycarbonate resin, the polycarbonate oligomer, and the flowability enhancing agent.

A method for producing the resin composition in accordance with an embodiment of the present invention is not limited to any particular method. The resin composition is produced by a publicly known method in which the flowability enhancing agent, the polycarbonate resin, the polycarbonate oligomer, and, as necessary, an additive such as a light diffusing agent are blended and melted and kneaded with use of, for example, a device such as a Henschel mixer, a Banbury mixer, a single screw extruder, a twin screw extruder, a two-roll mill, a kneader, or a Brabender. A temperature at which the flowability enhancing agent, the polycarbonate resin, the polycarbonate oligomer, and, as necessary, the additive are melted and kneaded is preferably as low as possible for a purpose of prevention of yellowing of the resin composition which yellowing is caused by, for example, (i) a transesterification reaction between the polyester, included in the flowability enhancing agent, and the polycarbonate resin or the polycarbonate oligomer and (ii) a deterioration of the polycarbonate resin composition due to heat.

By variously extrusion-molding the resin composition in accordance with an embodiment of the present invention, it is possible to mold the resin composition into, for example, variously shaped extrusion molded articles, an extrusion molded sheet, an extrusion molded film, and the like, each of which is the molded article in accordance with an embodiment of the present invention. Examples of such various extrusion molding methods include a cold runner molding method and a hot runner molding method as well as injection molding methods such as injection compression molding, injection press molding, gas-assisted injection molding, foam molding (including a case where a supercritical fluid is injected), insert molding, in-mold coating molding, heat-insulated mold molding, rapid heating/cooling mold molding, two color molding, sandwich molding, and ultra-high-speed injection molding. Alternatively, an inflation method, a calendar method, a casting method, or the like can be also employed so as to mold the resin composition into a sheet or a film. Furthermore, it is possible to mold the resin composition into a heat shrinkable tube by conducting a specific stretching operation. Further, it is possible to mold the resin composition in accordance with an embodiment of the present invention into a hollow molded article by, for example, rotation-molding or blow-molding the resin composition.

The molded article in accordance with an embodiment of the present invention can be used for a wide range of purposes such as various casings, hard coat products, glazing materials, light diffusing plates, optical disc substrates, light guide plates, medical materials, and sundry goods. Specifically, the molded article in accordance with an embodiment of the present invention can be used, for example, as exterior materials of OA equipment and household appliances; various containers; sundry goods; exterior materials such as personal computers, notebook computers, game machines, display devices (such as CRTs, liquid crystal displays, plasma displays, projectors, and organic EL displays), computer mice, printers, copy machines, scanners, and facsimiles (including multifunction machines made up of a printer, a copy machine, a scanner, and/or a facsimile); and resin products provided to keyboard keys, switch molded articles, mobile information terminals (so-called PDAs), mobile phones, mobile books (such as dictionaries), portable televisions, drives of recording media (such as CDs, MDs, DVDs, blue-ray discs, and hard disks), reading devices of recording media (such as IC cards, smart media, and memory sticks), optical cameras, digital cameras, parabolic antennas, power tools, VTRs, irons, hair dryers, rice cookers, microwave ovens, audio equipment, lighting equipment, refrigerators, air conditioners, air purifiers, negative ion generators, typewriters, and the like. Further, the molded article in accordance with an embodiment of the present invention is also useful for trays, cups, dishes, shampoo bottles, OA casings, cosmetic bottles, beverage bottles, oil containers, injection molded articles (such as golf tees, cores of cotton swabs, candy bars, brushes, toothbrushes, helmets, syringes, dishes, cups, combs, razor handles, tape cassettes and cases, disposable spoons and forks, and stationery such as ballpoint pens), and the like.

Further, the molded article in accordance with an embodiment of the present invention can be used in various fields such as banding tapes (binding bands), prepaid cards, balloons, pantyhose, hair caps, sponges, scotch tapes, umbrellas, raincoats, plastic gloves, hair caps, ropes, tubes, foam trays, foam cushioning materials, cushioning materials, packing materials, and cigarette filters.

Further, the molded article in accordance with an embodiment of the present invention can be used for vehicle parts such as lamp sockets, lamp reflectors, lamp housings, instrumental panels, center console panels, deflector parts, car navigation parts, car audio visual parts, and auto mobile computer parts.

The present invention can also encompass a method for enhancing flowability of a polycarbonate resin with use of the above-described flowability enhancing agent. In other words, the present invention can encompass a method for enhancing flowability of a polycarbonate resin, the method including a step of mixing the above-described flowability enhancing agent and the polycarbonate resin together. As another embodiment, the method for enhancing flowability of a polycarbonate resin with use of the above-described flowability enhancing agent can be expressed as use of the above-described flowability enhancing agent so as to enhance flowability of a polycarbonate resin.

### EXAMPLES

The following description will discuss, in more detail, an additive in accordance with an embodiment of the present invention and a resin composition in accordance with an embodiment of the present invention with reference to Production Example, Example, and Comparative Example. Note, however, that the present invention is not limited to such Example. Note that reagents manufactured by Wako Pure Chemical Industries, Ltd. were used below without being refined, unless otherwise specified.

<Evaluation Method>

[Method for Measuring Number Average Molecular Weight]

A sample solution was prepared by dissolving a flowability enhancing agent in accordance with an embodiment of the present invention in a mixed solvent, containing p-chlorophenol (manufactured by Tokyo Chemical Industry Co., Ltd.) and toluene at a volume ratio of 3:8, so that a concentration of the flowability enhancing agent became 0.25% by mass. Polystyrene was used as a standard substance, and a similar sample solution was prepared. Then, a number average molecular weight of the flowability enhancing agent was measured at a column temperature of 80° C. and a flow rate of 1.00 mL/minute with use of a high temperature GPC (350 HT-GPC System manufactured by Viscotek Co.). A differential refractometer (RI) was used as a detector.

[Method for Measuring Flowability]

A spiral flow (mm) of a resin composition was evaluated with use of an injection molding machine (IS-100, manufactured by Toshiba Machine Co., Ltd.). A polycarbonate resin composition was molded at a molding temperature of 280° C., a mold temperature of 100° C., and an injection pressure of 200 MPa. A molded article had a thickness of 1 mm and a width of 10 mm.

[Method for Measuring Flexural Modulus and Flexural Strength]

A flexural modulus (MPa) and flexural strength (MPa) of the resin composition were measured with use of AUTOGRAPH AG-I (manufactured by Shimadzu Corporation) according to JIS K7171 (measurement temperature: 23° C.; dimensions of a bending test piece: 80 mm long×10 mm wide×4 mm thick) so as to evaluate mechanical properties.

[Method for Measuring Deflection Temperature Under Load]

A deflection temperature (° C.) under load of the resin composition was measured with use of HOT.TESTER S-3 (manufactured by TOYO SEIKI SEISAKU-SHO, LTD) according to JIS K7191 (test conditions: load: 1.8 MPa; a rate of temperature increase: 120° C./hour) so as to evaluate heat resistance.

[Method for Measuring IZOD Impact Strength]

According to ASTM D256, a notched test piece was prepared from the resin composition, and IZOD impact strength (J/m) of the test piece was measured.

[Method for Measuring Total Light Transmittance and Haze]

A test piece of 4 cm long×4 cm wide×2 mm thick was prepared by injection molding, and total light transmittance (%) and haze (%) of the resin composition were measured with use of a haze meter HZ-V3 (manufactured by Suga Test Instruments Co., Ltd.).

[Method for Measuring Initial Yellowing Index (YI)]

A test piece of 4 cm long×4 cm wide×2 mm thick was prepared by injection molding, and initial yellowing index (YI) of the resin composition was measured with use of a spectrocolorimeter SCP (manufactured by Suga Test Instruments Co., Ltd.).

<Materials Used>

[Resins]

(A-1) Polycarbonate: lupilon 53000 (manufactured by Mitsubishi Engineering Plastics Corporation, having a viscosity average molecular weight of 22,000)

(A-2) Polycarbonate oligomer: lupilon AL-071 (Mitsubishi Engineering Plastics Corporation)

[Antioxidants]

(B-1) Phosphite antioxidant: PEP36 (manufactured by ADEKA Corporation)

(B-2) Hindered phenol antioxidant: A060 (manufactured by ADEKA Corporation)

### Production Example 1

In a sealed reactor equipped with a reflux condenser, a thermometer, a nitrogen gas inlet tube, and a stirring bar, 4,4′-dihydroxybiphenyl, bisphenol A, and sebacic acid at a molar ratio of 20:30:50 were introduced. Then, 1.05 equivalents of acetic anhydride with respect to phenolic hydroxyl groups in such monomers was added. The monomers were reacted at an ordinary pressure, under a nitrogen gas atmosphere, and at a temperature of 145° C. so that a homogeneous solution was obtained. Thereafter, the temperature was increased to 240° C. at a rate of 2° C./minute while generated acetic acid was distilled off, and the solution was stirred at a temperature of 240° C. for 2 hours. While the temperature was kept at 240° C., the pressure was reduced to 5 Torr over about 60 minutes and then a reduced pressure state was maintained. After 3 hours from a start of a reduction in the pressure, the pressure inside the sealed reactor was returned to the ordinary pressure with use of a nitrogen gas. The antioxidants (B-1) and (B-2) each in an amount of 0.2% by mass with respect to a mass of a produced polyester were added, and a resultant solution was stirred for 5 minutes to obtain a flowability enhancing agent (C-1). Thereafter, the flowability enhancing agent was taken out from the reactor. The obtained polyester had a number average molecular weight of 10,200. The obtained polyester was referred to as (D-1).

### Example 1, Comparative Example 1

Resins, antioxidants, and a flowability enhancing agent which was obtained in Production Example 1 were blended in proportions (parts by weight) shown in Table 1, supplied to a twin screw extruder, and then melted and kneaded at a temperature of 260° C. As a result, a resin composition was obtained for evaluation of performance of the flowability enhancing agent. Then, the performance of the flowability enhancing agent was evaluated by measuring physical properties of the resin composition. Table 2 shows the physical properties of the resin composition.

TABLE 1

| | | | Comparative |
|---|---|---|---|
| | | Example | Example |
| | | 1 | 1 |
| Resin | (A-1) | 90 | 95 |
| (Parts by weight) | (A-2) | 5 | 5 |
| Antioxidant | (B-1) | 0.2 | 0.2 |
| (Parts by weight) | (B-2) | 0.2 | 0.2 |
| Flowability | (C-1) | 5 | |
| enhancing agent | | | |
| (Parts by weight) | | | |

TABLE 2

| | | Comparative |
|---|---|---|
| | Example | Example |
| | 1 | 1 |
| Spiral flow (mm) | 100 | 90 |
| Deflection temperature under | 133 | 123 |
| load (° C.) | | |
| Flexural strength (MPa) | 99 | 98 |
| Flexural modulus (MPa) | 2544 | 2553 |
| IZOD impact strength (J/m) | 833 | 867 |
| Haze (%) | 0.79 | 0.64 |
| Total light transmittance (%) | 87.43 | 88.73 |
| YI (—) | 1.5 | 1.59 |

According to a comparison between Example 1 and Comparative Example 1, it was found that addition of the flowability enhancing agent in accordance with an embodiment of the present invention allows enhancement of flowability (spiral flow) of the resin without loss of flexural strength, a flexural modulus, impact strength, and optical properties (haze, total light transmittance, YI).

### INDUSTRIAL APPLICABILITY

According to a flowability enhancing agent in accordance with an aspect of the present invention, it is possible to enhance flowability of a polycarbonate resin during molding of the polycarbonate resin, without loss of inherent properties (for example, transparency, mechanical strength, and heat resistance) of the polycarbonate resin. Therefore, a polycarbonate resin composition in accordance with an aspect of the present invention makes it possible to produce a molded article that is larger, thinner, and/or more complicated in shape, and is suitably used for a wide range of purposes such as electric equipment, electronic equipment, OA equipment, optical parts, precision machinery, motor vehicles, security and medical care, building materials, and sundry goods.

1. A polycarbonate resin composition, comprising:
a flowability enhancing agent;
a polycarbonate oligomer; and
a polycarbonate resin,
wherein the flowability enhancing agent comprises a polycondensate of a monomer mixture including 0 mol % to 55 mol % of a biphenol component (A), 5 mol % to 60 mol % of a bisphenol component (B), and 40 mol % to 60 mol % of a dicarboxylic acid component (C), with respect to 100 mol % of a total amount of the biphenol component (A), the bisphenol component (B), and the dicarboxylic acid component (C),
the biphenol component (A) has formula (1): 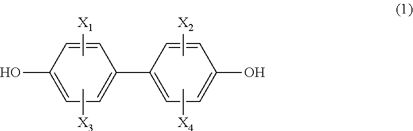
where X₁ through X₄ each independently represent a hydrogen atom, a halogen atom, or an alkyl group having 1 to 4 carbon atom(s) and may be identical to or different from each other,
the bisphenol component (B) being represented by the following general has formula (2): 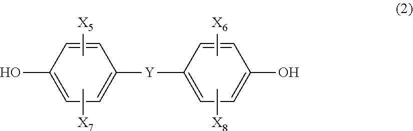
where X₅ through X₈ each independently represent a hydrogen atom, a halogen atom, or an alkyl group having 1 to 4 carbon atom(s) and may be identical to or different from each other; Y represents a methylene group, an isopropylidene group, a cyclic alkylidene group, an aryl-substituted alkylidene group, an arylenedialkylidene group, —S—, —O—, a carbonyl group, or —SO₂—,
the dicarboxylic acid component (C) has formula (3):
HOOC—R₁—COOH (3)
where R₁ represents a divalent linear substituent which has 2 to 18 atoms in a main chain thereof and which optionally contains a branch,
the polycarbonate oligomer has a structural unit of formula (4) having an average number of repetition of 2 to 15: 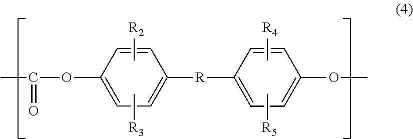
where R represents a linear, branched, or cyclic alkylidene group having 1 to 10 carbon atom(s), an aryl-substituted alkylidene group, an arylenedialkylidene group, an oxygen atom, a sulfur atom, a carbonyl group, or a sulfonyl group; and R₂ through R₅ each independently represent a hydrogen atom, a halogen atom, or an alkyl or alkenyl group having 1 to 4 carbon atom(s) and identical to or different from each other, and
the polycarbonate resin has a viscosity average molecular weight of not less than 15,000.

2. The polycarbonate resin composition of claim 1, wherein the flowability enhancing agent has a number average molecular weight of 2000 to 30000.

3. The polycarbonate resin composition of claim 1, wherein R₁ in the formula (3) is a linear saturated aliphatic hydrocarbon chain.

4. The polycarbonate resin composition of claim 1, wherein R₁ in the formula (3) has an even number of atoms in a skeleton of the main chain.

5. The polycarbonate resin composition of claim 1, wherein
not less than 50% of terminals of the flowability enhancing agent are sealed with a monofunctional low molecular weight compound.

6. A molded article, obtained by a process including molding a polycarbonate resin composition of claim 1.

7. The polycarbonate resin composition of claim 1, wherein X₅ through X₈ in the formula (2) are hydrogen atoms.

8. The resin composition of claim 1, wherein the bisphenol (B) in the monomer mixture comprises 2,2-bis(4-hydroxyphenyl)propane.

9. The resin composition of claim 1, wherein not less than 70% of the terminals of the flowability enhancing agent are sealed with the monofunctional low molecular weight compound.

10. The resin composition of claim 1, wherein the monofunctional low molecular weight compound comprises at least one selected from the group consisting of a monovalent phenol, a monoamine having 1 to 20 carbon atom(s), an aliphatic monocarboxylic acid, a carbodiimide, an epoxy, and an oxazoline.

11. The resin composition of claim 1, wherein R₁ in the formula (3) is one of —(CH₂)₈—, —(CH₂)₁₀— and —(CH₂)₁₂—, and does not have a branch.

12. The resin composition of claim 1, wherein the flowability enhancing agent is included in an amount of 0.1 to 30 mass %, the polycarbonate oligomer is included in an amount of 1 to 10 mass %, and the polycarbonate resin is included in an amount of 60 to 98.9 mass %, with respect to 100 mass % of the polycarbonate resin composition.

13. The resin composition of claim 1, wherein the polycarbonate resin has a viscosity average molecular weight from 15,000 to 22,000.

14. The resin composition of claim 1, wherein the polycarbonate oligomer has an average number of 4 to 12 repetitions.

15. The resin composition of claim 1, further comprising:
a phosphite antioxidant.

16. The resin composition of claim 1, wherein R in the formula (4) is an isopropylidene group.

17. The resin composition of claim 1, wherein R₂ through R₅ in the formula (4) are hydrogen atoms.

18. The resin composition of claim 1, further comprising:
at least one additive selected from the group consisting of a reinforcer, a thickener, a mold release, a coupling agent, a flame retarder, a flame-resistant agent, a pigment, a coloring agent, a light diffusing agent, an inorganic filler, an auxiliary agent, and a filler.
